(19) United States
(12) Patent Application Publication
(10) Pub. No.: US 2021/0012219 A1
(43) Pub. Date: Jan. 14, 2021

(54) DYNAMIC GENERATION OF RULE AND LOGIC STATEMENTS

(71) Applicant: SAP SE, Walldorf (DE)

(72) Inventors: Jan Portisch, Bruchsal (DE); Sandra Bracholdt, Dielheim (DE); Michael Monych, Mannheim (DE); Volker Saggau, Bensheim (DE)

(73) Assignee: SAP SE, Walldorf (DE)

(21) Appl. No.: 16/507,465

(22) Filed: Jul. 10, 2019

(51) Int. Cl. G06N 5/02; G06N 7/00

(52) U.S. Cl. CPC G06N 5/025; G06N 7/005

(57) ABSTRACT

Automatic rule generation is provided herein for generating data mapping, data transformation, or process flow rules or logic statements. The rules may be generated based on a field or attribute, and may be further based on a partial rule or one or more existing rules, or a combination thereof. Proposed rules may be generated based on analysis of a data set, including identifying possible values for the attribute and to calculate scores for the possible values. A score may be the probability of the value based on the data set. The data set may be cleaned or scrubbed based on the partial rule or existing rules. The proposed rules may be provided to a user, or may be automatically selected. Rule generation may include constraint checking. Constraint checking may include detecting empty data sets or detecting when two rules are not mutually exclusive.

### BACKGROUND

The amount of data in database and enterprise systems continues to increase at a high pace. In practice, such data is often stored in data silos that prevent full utilization. The different data silos may be matched together, identifying equivalent data or schemas between the data silos, which may allow greater integration or use of the data. However, matching data silo schemas or data silo data often requires the cumbersome, manual process of rule building by domain experts or consultants, so it is very labor-intensive and costly. Thus, there is room for improvement.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of generating a proposed logic statement is provided herein. An attribute identifier of an attribute having a set of possible values may be received. A data set may be accessed, and the data set may be at least partially defined by the attribute. A set of probability scores of the attribute may be calculated based on the data set. A given probability score may correspond to a given value of the set of possible values of the attribute. At least one proposed value from the set of possible values of the attribute may be provided, based on the set of probability scores.

A method of providing one or more proposed logic statements is provided herein. A request for a proposed logic statement may be received. The request may include a requested attribute identifier of an attribute having a set of possible values and a partial rule having at least a first rule attribute associated with a first rule value. A data set having one or more records may be accessed. The data set may be at least partially defined by the requested attribute and the first rule attribute. The data set may be filtered. Filtering may include removing one or more records from the data set where the first rule value does not match the first rule attribute. A set of probability scores of the requested attribute may be calculated based on the filtered data set. A given probability score may correspond to a given value of the set of possible values of the requested attribute. At least one proposed logic statement including the requested attribute and a proposed value from the set of possible values may be provided based on the set of probability scores.

A method for automatic logic statement generation is provided herein. A request for a proposed logic statement may be received. The request may include a requested attribute identifier of an attribute having a set of possible values and a partial rule comprising at least a first rule attribute associated with a first rule value. A data set having one or more records may be accessed. The data set may be at least partially defined by the requested attribute and the first rule attribute. The data set may be updated. Updating the data set may include removing one or more records from the data set that match an existing rule. The updated data set may be filtered. Filtering the data set may include removing one or more records from the updated data set that do not have the first rule value of the first rule attribute. A set of probability scores of the requested attribute may be calculated based on the updated and filtered data set. A given probability score may correspond to a given value of the set of possible values of the requested attribute. The set of possible values of the requested attribute may be sorted based on their respective probability scores. At least one proposed logic statement including the requested attribute identifier and a proposed value from the set of possible values may be provided based on the set of probability scores.

The foregoing and other objects, features, and advantages of the invention will become more apparent from the following detailed description, which proceeds with reference to the accompanying figures.

### BRIEF DESCRIPTION OF THE DRAWINGS

FIG. 1A is an architecture diagram depicting a system for automatic rule building.

FIG. 1B is an architecture diagram depicting a rule builder and a multitenant database arrangement.

FIG. 2 is a diagram depicting an example probability tree for rule attributes.

FIG. 3A is a flowchart illustrating a process for automatic rule generation.

FIG. 3B is a flowchart illustrating a process for data set rule constraint checking.

FIG. 3C is a flowchart illustrating a process for mutual exclusion rule constraint checking.

FIGS. 4A-C are diagrams depicting an example process for rule building with an attribute.

FIGS. 5A-D are diagrams depicting an example process for rule building with an attribute and a partial rule.

FIGS. 6A-D are diagrams depicting an example process for rule building with an attribute, a partial rule, and an existing rule.

FIGS. 7A-B are diagrams depicting an example process for data set constraint checking.

FIGS. 8A-B are diagrams depicting an example process for mutual exclusion constraint checking.

FIG. 9A is a schematic diagram depicting an application environment for a rule building module.

FIG. 9B is a schematic diagram depicting a system environment for a rule building module.

FIG. 9C is a schematic diagram depicting a network environment for a rule building module.

FIG. 10 is a diagram of an example computing system in which described embodiments can be implemented.

FIG. 11 is an example cloud computing environment that can be used in conjunction with the technologies described herein.

### DETAILED DESCRIPTION

### EXAMPLE 1

### Clustering within a Data Model Overview

The ever-increasing amount of incoming data and transformation of the enterprise into a data-driven world creates many difficulties as data is indeed accumulated, but not always in an organized or arranged manner. Often, data is split into different operational and analytical systems, and stored in data silos, which can prevent effective use of the full potential of the data. Essentially data segregation into data silos leads to semantic and technological heterogeneity, resulting in analytical barriers. Overcoming the heterogeneity between data silos may be accomplished by finding an alignment between the disparate data schemas, such as by the process of schema matching.

Within this schema matching process, rules can be created that describe how the data is transformed from one schema into the other. Similarly, such rules may also be developed for triggering system or software functionality, or directing a process flow or work flow in a computing system.

Generally, rule writing is a manual process, with little to no technical support and lacking intelligent functionality such as smart auto-complete, semantic checks, or constraint checking.

There are many scenarios where generating rules for mapping data transformations or directing process flows can be helpful. As a first example, it can be important in many enterprise systems that certain conditions (e.g. rules) only be activated once. An entity may obtain a new data model and have specialists persist their current rules into the new data model, rules such as “is premium user” or “is standard user.” Complex or extensive rules make avoiding such overlap even harder, as does transferring the rules into the new data model. Ensuring that the rules do not overlap or that two rules are not simultaneously met or triggered can be important for avoiding runtime errors or generating conflicting results. Further, ensuring multiple rules are not triggered together can improve runtime performance, as it reduces and efficiently streamlines processing by preventing or avoiding duplicative or unnecessary steps.

As another example, it can be desired in many enterprise systems that rules that never activate (e.g. cannot be triggered) are not included. An entity may obtain a new data model and have specialists persist their current rules into the new data model, such as a rule: “is born before 1950” AND “is youth user.” Such a rule generally cannot be triggered. Complex or extensive rules make avoiding such extraneous rules even harder, as does transferring the rules into the new data model. Ensuring that extraneous rules are not in the system can be important for avoiding runtime errors or improving system performance, as it can reduce and efficiently streamline processing by removing rules that do not need to be processed (as they will not trigger) and improving the maintainability of the rule set by reducing the complexity of the rule set. Such extraneous rules are often difficult to discover through manual debugging, requiring extensive time and specialist manpower.

As another example, an entity may obtain a new data model and have specialists persist rules into the new data model. The specialist may need to repeatedly consult an SQL console (or other system interface) for fields or values available for the rules. The specialist may also need to repeatedly consult the SQL console for existing rules or relationships between rules. The specialist may need to write complex queries to determine details about the distribution of specific characteristics or values. Referencing separate systems, including performing manual data mining on other systems or databases, can significantly impact the productivity of the specialist, making development of rules slower and more costly. Further, such activity can increase the risk of errors introduced into the rules, which can lead to poor or inaccurate system performance later.

Automatic rule generation and constraint checking as described herein generally can alleviate these issues, in some cases removing them entirely, and generally improves system performance and result accuracy. Automatic rule generation can take the form of generating a partial logic statement, or a complete logic statement, or the like. Automatic rule generation may include of generating a set of proposed values for a field or attribute to be used in a rule (e.g. “V1A” for an attribute called ‘field1’). Further, automatic rule generation may include generating a set of proposed values and a comparator (e.g. equivalence, greater than, etc.) for a field or attribute to be used in a rule, such as a partial logic statement (e.g. “=‘V1A’” for an attribute called ‘field1’). Automatic rule generation may further include generating a rule or other complete logic statement, such as “field1=‘V1A’.” In some embodiments, such complete logic statements generated as described herein may be integrated (e.g. concatenated or appended) with another rule, such as a partial rule or incomplete rule, which may be a larger or more complex rule.

A rule may be a first order logic statement which evaluates to true or false. A rule may be composed of multiple partial rules or logic statements (which may be complete rules or logic statements themselves). Rules may also form rule sets, or collections of one or more rules. A rule set may be a mapping, which may be a set of rules covering a particular piece of functionality or a given processing scenario.

Rules may be used to determine a process flow or a work flow. Additionally, rules may be used to identify instance data from a data set, such as records in a database. Such identification may be used to sort, map, transform, process or otherwise manipulate particular sets of records. Thus, instance data, such as database records, may be processed or manipulated using rules. Mappings may cover larger sets of instance data, or additional processing flows. Mappings may also integrate different sets or subsets of data or functionality.

Instance data may also be used in generating rules, as described herein. Instance data may be mined and analyzed for automatically generating proposed rules, which may be used in software development by both technical and non-technical developers, such as through an IDE.

Mining instance data may provide information about the probability of particular rules being triggered, or evaluating to true. Thus, mining the instance data may be part of using the instance data to generate proposed rules. For example, the instance data may be used to calculate the probability of a particular attribute or field having a particular value, e.g. meeting that rule. Further, a probability tree can be generated based on the instance data to more fully calculate the probabilities for different values of different fields in varying combinations. Such probability trees may be used in automatic rule generation as described herein.

The automatic rule generation and constraint checking functionality may be integrated with other rule writing or rule persistence technology. Rule writing functionality may include the rule language technologies disclosed in U.S. patent application Ser. No. 16/265,063, titled “LOGICAL, RECURSIVE DEFINITION OF DATA TRANSFORMATIONS,” filed Feb. 1, 2019, having inventors Sandra Bracholdt, Joachim Gross, and Jan Portisch, and incorporated herein by reference, which may be used as a rule-writing system or language for generation, development, storage, or maintenance of logic statements or rules as described herein. Further, rules for mapping or data transformations, such as between data models or schemas, may utilize the metastructure schema technologies disclosed in U.S. patent application Ser. No. 16/399,533, titled “MATCHING METASTRUCTURE FOR DATA MODELING,” filed Apr. 30, 2019, having inventors Sandra Bracholdt, Joachim Gross, Volker Saggau, and Jan Portisch, and incorporated herein by reference, which may be used as data model representations for analysis, storage, development, or maintenance of logic statements or rules as described herein.

Automatic rule generation and constraint checking functionality may be provided in data modeling software, integrated development environments (IDEs), data management software, data integration software, ERP software, or other rule-generation or rule-persistence software systems. Examples of such tools are: SAP FSDP™ technology, SAP FSDM™ technology, SAP PowerDesigner™ technology, SAP Enterprise Architect™ technology, SAP HANA Rules Framework™ technology, HANA Native Data Warehouse™ technology, all by SAP SE of Walldorf, Germany.

### EXAMPLE 2

### Automatic Rule Builder Architecture

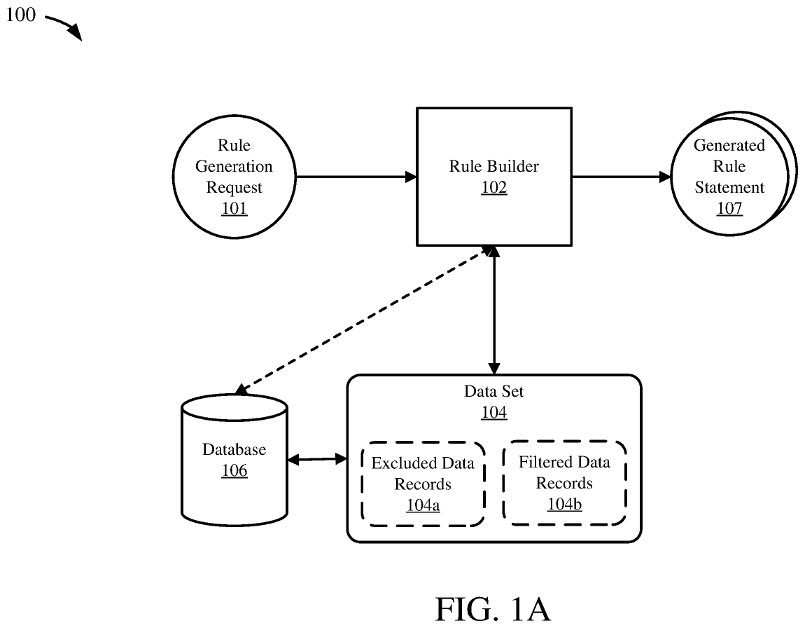

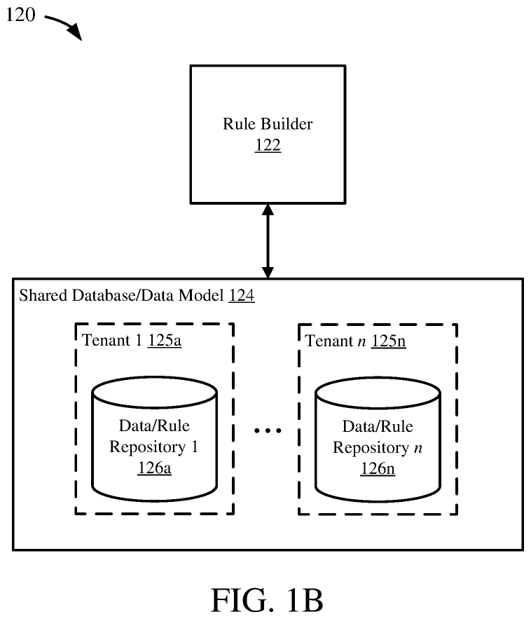

FIG. 1A is an architecture diagram depicting a system 100 for automatic rule building. A rule builder 102 may automatically generate one or more rules or rule proposals 107, such as logic statements, as described herein. The rule builder 102 may provide automatic rule generation functionality directly, or it may be integrated in an application, such as an integrated development environment (IDE) or with a user interface.

The rule builder 102 may receive a rule generation request 101. The request 101 may be a function call or may be made through an API or other interface of the rule builder 102. In some embodiments, the request 101 may be a trigger which initiates functionality in the rule builder 102, such as based on an input or a context change.

The rule generation request 101 may include one or more variables for generating the request rule. The request 101 may include an attribute name or field name, or other identifier, for a field in a data set or a variable. For the sake of brevity, an attribute name is sometimes herein called an “attribute.” The attribute may identify the variable for use as the base of the requested rule. For example, for a rule “field1=‘V1A’,” the attribute provided as part of the request 101 may be “field1” and the remainder of the rule, “=‘V1A’” may be determined by the rule builder 102. An attribute may define or partially define a data set (e.g. may be a field or column in a data set).

The request 101 may further include a partial rule. Generally, the partial rule can be the remainder of a rule currently in development that is not the attribute. For example, for a rule “field1=‘V1A’ and field2=‘V2A’,” the partial rule may be “field1=‘V1A’” while the attribute may be “field2” and the remainder of the rule, “=‘V2A’” may be determined by the rule builder 102.

The request 101 may further include one or more existing rules. The existing rules may be complete rules that are related to the rule currently being developed (e.g. requested for automatic generation). Existing rules may be grouped into a rule set, also called a mapping. Rules within the same mapping are generally related. Existing rules included in a rule generation request 101 are generally in the same mapping as the rule being requested for generation. A mapping may be applied to map one schema to another schema, or to transform data, such as in an ETL process. Alternatively or additionally, a mapping may be applied to a work flow to direct or process input data, such as data records. A mapping may accordingly encapsulate specific functionality as a set of rules or logic statements.

The rule generation request 101 may also include a data set, such as data set 104, for generating the request rule. In some embodiments, the request 101 may include the data set 104 itself, or an identifier or memory location for a data set. In other embodiments, the request 101 may include an identifier for a data source, such as a database 106, from which a data set 104 may be obtained.

In some embodiments, the attribute, partial rule, and mapping or existing rules may be provided directly as part of the rule generation request 101. In other embodiments, identifiers or memory locations may be provided for the attribute, partial rule, or mapping in the request 101. In some embodiments, such as when the request 101 is a trigger, the attribute, partial rule, and mapping may be available for the rule builder 102 as part of the system 100 context, rather than being provided as part of the request 101. For example, in an IDE, the rule builder 102 may be activated by a user entering an attribute name (e.g. “field1”) for a rule, which may trigger the rule builder to begin automatically generating one or more proposed rules for the attribute based on other information in the current context of the IDE, such as a partial rule or other existing rules in the IDE.

The rule generation request 101 may also include one or more configurable configuration settings or options, such as a value indicating a preferred number of generated rule statements or a threshold score for generated rule statements.

The rule builder 102 may access a data set 104 for generating rule statements 107 as described herein. The data set 104 may be obtained from a database 106, such as based on the rule generation request 101. The data set 104 may include instance data for the attribute included in the request 101. For example, the data set 104 may be a set of records from a database 106 of which one of the values in the records (e.g. a column) is the attribute provided in the request 101. The data set 104 may be a complete data set of all records available in the data source (e.g. database 106), or may be a subset of the records available. For example, the data set 104 may be a sampling of the records available, such as a statistically significant or representative sampling of the records.

The rule builder 102 may analyze the data set 104 to determine one or more possible values for the attribute, a comparator (e.g. equivalence), and to calculate a score for the separate possible values. The rule builder 102 may use the determined possible values, comparator, and scores to generate and provide one or more generated rule statements 107. In some embodiments, the generated rule statements 107 may be rule proposals, which may be provided to a user or another system for selection. In other embodiments, the generated rule statements 107 may be automatically selected and inserted into the rule currently in development (e.g. the rule requested).

The rule builder 102 may clean or scrub the data set 104 as part of rule generation, by filtering or excluding some instance data in the data set. The rule builder 102 may filter records in the data set 104 which do not match the partial rule provided in the request 101. The filtered data records 104b may be records which have instance data for the attribute being used in the rule generation, but which do not match the partial rule (e.g. are not triggered or fired by the partial rule). For example, with a partial rule “field1=‘V1C’,” records where field1 has values other than “V1C,” such as “V1A” or “V1B,” may be filtered and become part of the filtered data records 104b. The filtered data records 104b are records which can be ignored or otherwise not used in generating the generated rule statements 107. In some embodiments, the filtered data records 104b may be removed from the data set 104, while in other embodiments the filtered data records may be flagged or otherwise indicated to not be used in processing, while in other embodiments the filtered data records may be skipped or ignored by the rule builder 102.

Filtering the data set 104 generally improves the performance of the rule builder 102, by avoiding processing records inapplicable to the current rule generation request. Further, filtering the data set 104 also improves the quality of the generated rule statements 107, by removing records which may skew the rule generation analysis or provide inaccurate or inapplicable proposed rules, such as by providing possible values which are not available based on the partial rule.

The rule builder 102 may also exclude records in the data set 104 which match the one or more existing rules provided in the rule request 101. The excluded data records 104a may be records which have instance data for the attribute being used in the rule generation, but which already match an existing rule (e.g. records that would be triggered, fired, or otherwise identified by existing rules). For example, with an existing rule “field1=‘V1A’,” records where field1 has the value “V1A” may be excluded and become part of the excluded data records 104a. The excluded data records 104a are records which can be ignored or otherwise not used in generating the generated rule statements 107. In some embodiments, the excluded data records 104a may be removed from the data set 104, while in other embodiments the excluded data records may be flagged or otherwise indicated to not be used in processing, while in other embodiments the excluded data records may be skipped or ignored by the rule builder 102.

Rule generation using such records may lead to generated rule statements 107 which duplicate or overlap with the existing rules. Excluding such records 104a generally improves the performance of the rule builder 102, by avoiding processing records inapplicable to the current rule generation request. Further, excluding some records in the data set 104 also improves the quality of the generated rule statements 107, by removing records which may skew the rule generation analysis or provide inaccurate or inapplicable proposed rules, such as by providing possible values which are duplicates of existing rules, or skewing the score values of some generated rule statements inaccurately towards less probable or valuable options.

Both filtering and excluding as part of cleaning the data set 104 encourages best practices development of rules, but integrated into automatic rule generation. Such practices lead to improved rule maintainability and system performance, with fewer errors which in turn leads to less debugging and lower maintenance requirements. To further such best practices, the rule builder 102 may also provide constraint checking functionality to assist in selection of generated rule statements 107, as described herein.

### EXAMPLE 3

### Rule Builder with Multitenancy

FIG. 1B is an architecture diagram depicting a rule builder and a multitenant database arrangement 120. A rule builder 122 may be used to mine instance data for one or more attributes, or existing rules (or both), from a shared database or data model 124, similar to FIG. 1A. The shared database or data model 124 may reside on a network (e.g. in the cloud) and may have one or more tenants, such as Tenants 1-n 125a-n, which access or otherwise use the shared database.

The tenants 125a-n may have their own respective sets of instance data or rules in the database 124, such as Data/Rule Repository 1 126a for Tenant 1 125a through Data/Rule Repository n 126n for Tenant n 125n. The data repositories 126a-n may include instance data for attributes available in the database/data model 124, or rules based on the database/data model (e.g. for mapping to another data model, etc.), or both. The data repositories 126a-n may reside outside tenant portions of the shared database 124 (e.g. secured data portions maintained separate from other tenants), so as to allow access by the rule builder 122 without allowing access to sensitive or confidential tenant information or data. The data repositories 126a-n may have any sensitive or confidential information masked or removed, or may have all data removed and only contain rules or partial rules (e.g. logic statements).

The rule builder 122 may access some or all of the data repositories 126a-n when mining the shared database 124. In this way, the broad knowledge developed across multiple tenants, and database developers or administrators of those tenants, may be accessed and used through data/rule mining, as described herein, to auto-generate or recommend rule statements, including portions of rule statements.

### EXAMPLE 4

### Attribute Probability Tree

A field or attribute (e.g. a data variable) may be used in a rule. The attribute may have a known set of possible values. The known set of possible values may be based on the definition of the attribute. For example, an attribute “field1” may be defined to have the possible values “V1A,” “V1B,” and “V1C.” In other cases, the known set of possible values may be based on a data set of instances of the attribute. For example, a database table storing instance data for “field1” may have the values “V1A,” “V1B,” and “V1C,” which may indicate that these values are at least the known possible values for field1 (other values may be possible). Instance data for an attribute may be actual data values for the attribute, such as values for the attribute in a record in a database. The following is an example of instance data for three attributes in ten records (each row is a record):

| | Field1 | Field2 | Field3 |
|---|---|---|---|
| 1. | V1A | V2A | V3A |
| 2. | V1A | V2B | V3C |
| 3. | V1A | V2B | V3A |
| 4. | V1A | V2B | V3B |
| 5. | V1A | V2A | V3A |
| 6. | V1A | V2A | V3B |
| 7. | V1A | V2C | V3A |
| 8. | V1B | V2C | V3B |
| 9. | V1B | V2A | V3B |
| 10. | V1C | V2A | V3A |

The instance data may be all available data for the attribute or attributes, or it may be a subset of the available instance data, such as a representative sample or statistical sampling. From the instance data, the probability of a given value occurring may be calculated.

| Field1 Value | Count | Probability |
|---|---|---|
| V1A | 7 | 7/10 = 70% |
| V1B | 2 | 2/10 = 20% |
| V1C | 1 | 1/10 = 10% |

| Field2 Value | Count | Probability |
|---|---|---|
| V2A | 5 | 5/10 = 50% |
| V2B | 3 | 3/10 = 30% |
| V2C | 2 | 2/10 = 20% |

| Field3 Value | Count | Probability |
|---|---|---|
| V3A | 5 | 5/10 = 50% |
| V3B | 4 | 4/10 = 40% |
| V3C | 1 | 1/10 = 10% |

Further, the probability of a given value for a given attribute may be further refined based on a known value for another attribute. For example, the probability of value “V2A” for attribute field2 may be calculated for when field1 has value “V1A.” In this example, there are seven instances of “V1A” for field1, and of those seven instances, field2 has value “V2A” in three instances. Thus, the probability of field2 having “V2A” when field1 has “V1A” is 3/7=43%.

Moreover, the probability of a given path, or set of values across multiple fields, may be calculated by multiplying the probability of each field having a particular value with the probability of the next field having a particular value. Continuing the example above, the probability for the path field1=“V1A” and field2=“V2A” is the probability of field1 having “V1A,” or 0.7 (70%), multiplied by the probability of field2 having “V2A” when field1 has “V1A,” or 0.43 (43%). Thus, the probability of path field1=“V1A” and field2=“V2A” is 0.7*0.43=0.3 (30%).

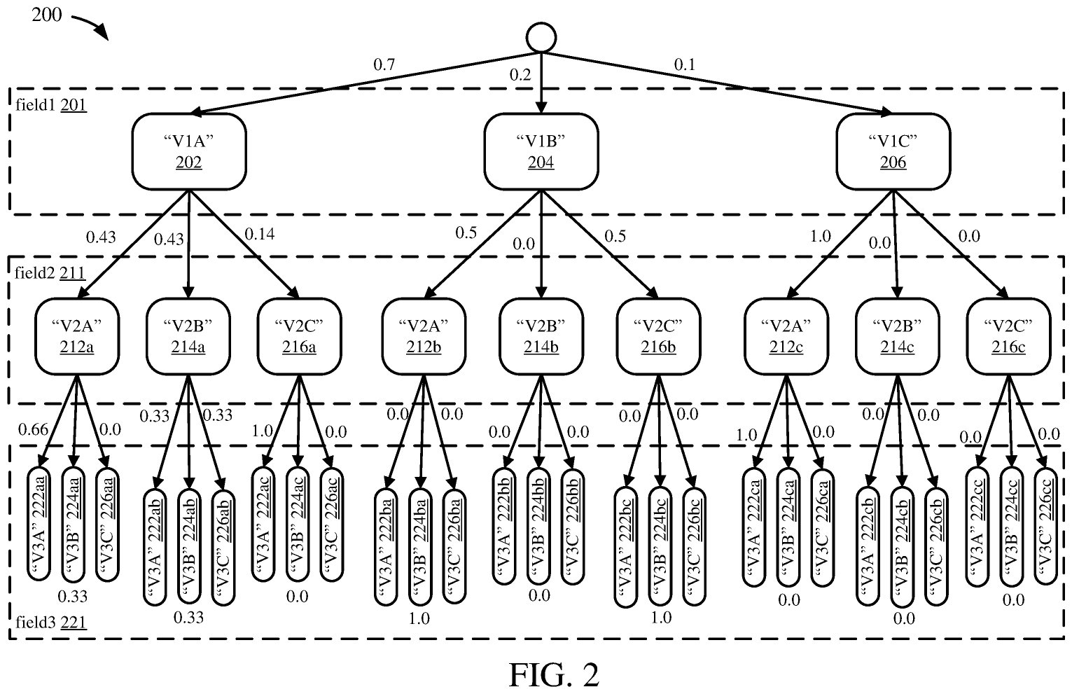

This probability distribution between attributes and values may be represented as a tree diagram 200, as shown in FIG. 2. The probability distribution tree 200 may represent three attributes as from the example above, field1 201, field2 211, and field3 221.

Field1 201 may have three possible values with a separate probability of occurring based on the data set in the example above: “V1A” 202 with a probability of 0.7, “V1B” 204 with a probability of 0.2, and “V1C” 206 with a probability of 0.1.

Field2 211 may have three possible values: “V2A” 212a-c, “V2B” 214a-c, and “V2C” 216a-c. Each of the possible values for field2 211 may follow the possible values of field1 201. Thus, following “V1A” 202, field2 211 may have the following values and probabilities: “V2A” 212a with a probability of 0.43, “V2B” 214a with a probability of 0.43, and “V2C” 216a with a probability of 0.14. Following “V1B” 204, field2 211 may have the following values and probabilities: “V2A” 212b with a probability of 0.5, “V2B” 214b with a probability of 0.0, and “V2C” 216b with a probability of 0.5. Following “V1C” 206, field2 211 may have the following values and probabilities: “V2A” 212c with a probability of 1.0, “V2B” 214c with a probability of 0.0, and “V2C” 216c with a probability of 0.0.

Field3 221 may have three possible values: “V3A” 222aa-cc, “V3B” 224aa-cc, and “V3C” 226aa-cc. Each of the possible values for field3 221 may follow the possible values of field2 211, which in turn follow the possible values of field1 201. Thus, following “V2A” 212a following “V1A” 202, field3 221 may have the following values and probabilities: “V3A” 222aa with a probability of 0.66, “V3B” 224aa with a probability of 0.33, and “V3C” 226aa with a probability of 0.0. Following “V2B” 214a following “V1A” 202, field3 221 may have the following values and probabilities: “V3A” 222ab with a probability of 0.33, “V3B” 224ab with a probability of 0.33, and “V3C” 226ab with a probability of 0.33. Following “V2C” 216a following “V1A” 202, field3 221 may have the following values and probabilities: “V3A” 222ac with a probability of 1.0, “V3B” 224ac with a probability of 0.0, and “V3C” 226ac with a probability of 0.0.

Similarly for field3 221 following “V2A” 212b following “V1B” 204, field3 221 may have the following values and probabilities: “V3A” 222ba with a probability of 0.0, “V3B” 224ba with a probability of 1.0, and “V3C” 226ba with a probability of 0.0. Following “V2B” 214b following “V1B” 204, field3 221 may have the following values and probabilities: “V3A” 222bb with a probability of 0.0, “V3B” 224bb with a probability of 0.0, and “V3C” 226bb with a probability of 0.0. Following “V2C” 216b following “V1B” 204, field3 221 may have the following values and probabilities: “V3A” 222bc with a probability of 0.0, “V3B” 224bc with a probability of 1.0, and “V3C” 226bc with a probability of 0.0.

Similarly for field3 221 following “V2A” 212c following “V1C” 206, field3 221 may have the following values and probabilities: “V3A” 222ca with a probability of 1.0, “V3B” 224ca with a probability of 0.0, and “V3C” 226ca with a probability of 0.0. Following “V2B” 214c following “V1C” 206, field3 221 may have the following values and probabilities: “V3A” 222cb with a probability of 0.0, “V3B” 224cb with a probability of 0.0, and “V3C” 226cb with a probability of 0.0. Following “V2C” 216c following “V1C” 206, field3 221 may have the following values and probabilities: “V3A” 222cc with a probability of 0.0, “V3B” 224cc with a probability of 0.0, and “V3C” 226cc with a probability of 0.0.

The probability that a given path, or set of values across the attributes, may be calculated by multiplying the probability of each value based on its predecessor. Thus, for “V1A” 202 in field1 201, “V2A” 212a in field2 211, and “V3A” 222ca in field3 221, the probability is 0.7*0.43*0.66=0.2 or 20% (0.19866).

The probability for some sets of values in the attributes may be zero in some cases. For example, for “V1A” 202 in field1 201, “V2A” 212a in field2 211, and “V3C” 226aa in field3 221 the probability is zero because there is not a record in the data set with that set of values (e.g. the probability of “V3C” 226aa after “V2A” 212a is zero).

A probability tree 200 may be calculated and stored in a tree structure (e.g. B+ tree), a tree-like structure (e.g. linked list, array), or other data structure or variable or set of variables. A probability tree for a data set may be pre-processed (e.g. generated) and stored, or may be calculated on-the-fly.

### EXAMPLE 5

### Automatic Rule Generation Process

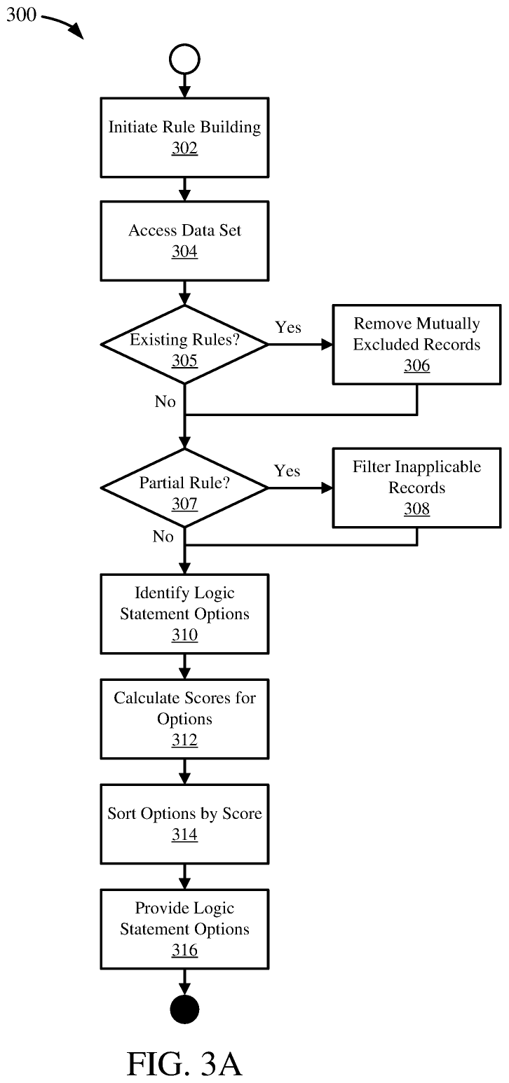

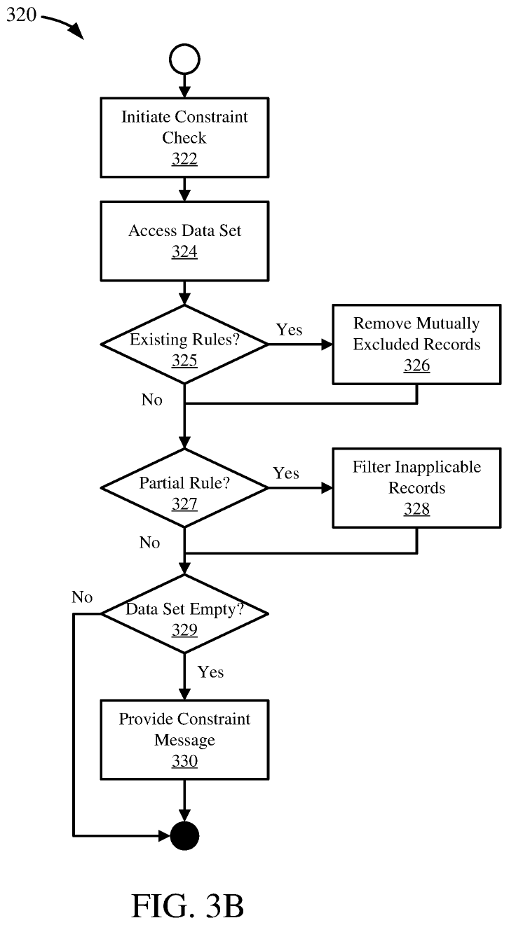

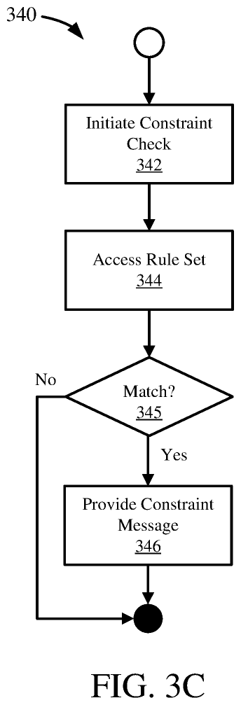

FIG. 3A is a flowchart illustrating a process 300 for automatic rule generation.

Rule building may be initiated at 302. Generally, initiating rule building at 302 may include receiving, accessing, or otherwise identifying an attribute or field for use in the rule being automatically generated by the process 300.

Initiating rule building at 302 may include receiving a rule building request. A rule building request may include one or more variables or input arguments, such as described herein. For example, a rule building request may include an attribute or attribute identifier, a partial rule or identifier for a partial rule, a data set or identifier for a data set (which may include location or other access information for the data set), or one or more current rules (e.g. a mapping) or identifiers for current rules (or a combination thereof).

Initiating rule building at 302 may include triggering automatic rule generation, such as by triggering a response in a computing system to a particular context, action, or input. For example, in a rule building context, entering an attribute identifier (e.g. field name) may trigger rule building at 302. In such embodiments, the automatic rule generation process 300 may access one or more variables or arguments in the current system or context for use in the rule building. Such variables may be similar to the variables received in a rule building request.

A data set may be accessed at 304. The data set accessed at 304 may be applicable or related to the rule being generated by the process 300. For example, the rule being generated by the process 300 may be applied to the data set once generated. Generally, the data set accessed at 304 includes the attribute that is the basis of the rule from step 302 (e.g. the data set can be at least partially defined by the attribute), and has one or more records with instance data, such as instance data of the attribute. The data set accessed may be the data set received or otherwise identified at 302. In some cases, the data set may be available in local memory. In other cases the data set may be available in a database or data repository (e.g. a file), and accessing the data set at 304 may include accessing the database or data repository and obtaining the data set or a sampling of the data set (e.g. a subset of all records available).

In some embodiments, the data set accessed at 304 may include one or more existing rules, such as in addition to instance data. Alternatively or additionally, a separate data repository may be accessed at 304 to obtain existing rules.

The process 300 determines the availability of any current or existing rules, related to the rule building initiated at 302, at 305. For example, if a mapping with one or more rules was provided or is otherwise available.

If there are one or more existing rules (“yes” at 305), then mutually excluded records may be removed at 306. Removing records at 306 may include identifying records that match at least one of the existing rules and removing those records from the data set. Records that match existing rules are records that may already be captured, identified by, or trigger (e.g. fire) existing rules, and so may not be beneficial in generating a new rule because a new rule based on data that matches an existing rule may cause the rules to be mutually exclusive (e.g. cover the same data). Thus, all the records that match each existing rule may be removed at 306. Removing a record at 306 may include deleting the record from the data set. Alternatively, removing a record at 306 may include setting a flag or other indicator for the record representing that the record has been removed (e.g. based on mutual exclusion) and can be skipped or otherwise not used in the rule building process 300.

If there are no existing rules (“no” at 305), or once the mutually excluded records are removed at 306, the process 300 determines the availability of a partial rule, related to the rule building initiated at 302, at 307. For example, if a partial or current rule was provided or is otherwise available. A partial rule may be one or more logic statements (e.g. field1=“V1A”) that form a rule that is being expanded or further built by the process 300.

If a partial rule is available (“yes” at 307), then the data set may be filtered at 308. Filtering the data set at 308 may include identifying records that match the partial rule and removing records that do not match the partial rule. Records that match the partial rule are applicable to the current process 300 generating the next logic statement for the partial rule, while records that do not match the partial rule are inapplicable, and so can be removed. Thus, all the records that do not match the partial rule may be removed at 308. Removing a record at 308 may include deleting the record from the data set. Alternatively, removing a record at 308 may include setting a flag or other indicator for the record representing that the record has been removed (e.g. based on mutual exclusion) and can be skipped or otherwise not used in the rule building process 300.

Alternatively, filtering the data set at 308 may include flagging or otherwise setting an indicator for each record that matches the partial rule to indicate the record should be used in generating the rule.

Generally, after filtering the data set at 308, the records remaining in the data set are applicable to the rule building process 300 (e.g. match the partial rule and do not match an existing rule).

If there is not a partial rule (“no” at 307), or once the data set is filtered at 308, logic statement options may be identified at 310. Identifying the logic statement options at 310 may include identifying the possible values for the input attribute from step 302. For example, an attribute “field1” may have possible values “V1A,” “V1B,” and “V1C.” The possible values may be identified based on the definition of the attribute, on the data set (e.g. values for the attribute found in the data set), or on configuration data for the attribute (or on a combination thereof). The logic statement options may be the possible values for the input attribute.

Additionally, the logic statement options may include a comparator for comparing the attribute to the possible values. Generally, the comparator may be equivalence (“=” or “==”), however, another comparator may be used depending on the type of the attribute and the data set. For example, for a numeric attribute a greater-than (“>”) or less-than (“<”) may be determined to be used for the logic statement option, such as based on the data set or existing rules. For example, an existing rule “field1<10” may be identified, and so a greater-than-or-equal-to comparator (“>=”) may be determined for use in the logic statement options.

Scores for the identified logic statement options may be calculated at 312. Calculating scores for the logic statement options may include calculating the probability of each option as described herein. In some embodiments, the score may be the probability of each option. Calculating the probability of each option may include calculating the probability of each possible value based on the data set. Alternatively or additionally, calculating the probability of each option may include calculating the probability for each option based on the partial rule, such as in a probability tree as described herein.

In some embodiments, the score may be based in part on the probability in addition to other data. For example, configuration information may be used to calculate the score in addition to the probability, such as preferences (e.g. weight values) for certain possible values.

In some embodiments, identifying the logic statement options at 310 and calculating the scores at 312 may be merged or integrated together. For example, calculating a probability tree as described herein may result in both the logic statement options (e.g. possible values for the attribute) and the score for each option (e.g. the probability for each attribute value).

The logic statement options may be sorted at 314. The sorting may be based on the scores for each option. For example, the options may be sorted in descending order of their scores, with the most probable options first. Additionally or alternatively, sorting at 314 may include filtering the options. For example, options with a score that does not meet a threshold may be removed from the set of options. As another example, a set number of options may be retained, such as the top three options, and other options may be removed. In some embodiments, an option may be automatically selected, such as the option with the highest score.

The logic statement options may be provided at 316. Providing the logic statement options may include providing their respective scores as well. The logic statement options provided at 316 may include a partial rule (e.g. “field1=‘V1A’”) or a partial logic statement (e.g. “=‘V1A’”), or a value for the attribute, which may generally be from the set of possible values for the attribute (e.g. “V1A”).

In some embodiments, the logic statement options may be provided as an ordered set, where the order indicates their relative strength or probability. The options may be provided at 316 through a user interface, which may allow for selection of an option for the rule being built in process 300. Alternatively or additionally, the logic statement options may be provided through an API, such as to another system, or through a messaging interface.

### EXAMPLE 6

### Categorical and Non-Categorical Attribute Values

Attributes may have possible values that are categorical or non-categorical. Categorical values are discrete values, which may generally be represented as a set of values for a given attribute. For example, field1 may have possible values “V1A,” “V1B,” and “V1C,” which are categorical, or discrete, values. Other attributes may have non-categorical values, such as numeric fields.

Automatic rule generation, as described herein, may be applied to attributes with non-categorical values using binning, such as equal-width binning or equal-frequency binning. A bin may be a range of possible values. Analysis of a data set for generating a rule may include placing records into one or more bins, or ranges of values, and then performing the probability analysis as described herein (e.g. where records in a bin have the “same” value). Heuristic algorithms may be further applied to facilitate binning, such as to determine the bins. Alternatively or additionally, one or more existing rules may be analyzed to determine bins for a non-categorical attribute, such as by determining bins that are mutually exclusive to the existing rules. The binning approach applied to a given attribute may be pre-determined, or may be based on a configurable setting(s), or may be determined on-the-fly, such as by analyzing the attribute type (e.g. determining the attribute is a numeric field).

The process 300 shown in FIG. 3A may include additional steps for binning. For example, an initial bin may be determined, such as based on the data set. For example, a bin of values greater than 5 may be proposed for field1 (e.g. field1>5), such as if the data set has more records where field1 is greater than 5. The bin may then be compared against any existing rules, to determine if that bin is already covered. For example, “field1>5” may already be included in an existing rule. The complement to that rule may then be determined or proposed, for example, “field1<=5.” The existing rules need not match the proposed bin exactly. For example, the proposal may be “field1>5” and the existing rule is “field1>4.” The complement may still be provided as the proposed rule, or analyzed against the data set as a proposed rule, which in this case would be “field1<=4.”

### EXAMPLE 7

### No Data Constraint Checking

FIG. 3B is a flowchart illustrating a process 320 for data set rule constraint checking. The process 320 may be integrated with the automatic rule generation process 300 or other constraint checking processes (e.g. 340), or some combination thereof. For example, steps 329 and 330 may be integrated into an automatic rule generation process 300.

Constraint checking may be initiated at 322, which may be similar to initiating rule building at 302 in process 300 as shown in FIG. 3A. In some embodiments, constraint checking at 322 may be integrated with initiating rule building at 302 in process 300. Further, constraint checking at 322 may be initiated by initiating rule building. Initiating constraint checking at 322 may include triggering constraint checking, such as by triggering a response in a computing system to a particular context, action, or input. For example, triggering may include initiating rule building or completing a new rule. In such embodiments, the constraint checking process 320 may access one or more variables or arguments in the current system or context for use in the constraint checking. Such variables may be similar to the variables received in a rule building request, or otherwise available, in process 300 as shown in FIG. 3A.

A data set may be accessed at 324, similar to accessing the data set at 304 in process 300 shown in FIG. 3A.

The process 320 determines the availability of any current or existing rules, related to the constraint check initiated at 322, at 325, similar to the existing rule check at 305 in process 300 shown in FIG. 3A.

If there are one or more existing rules (“yes” at 325), then mutually excluded records may be removed at 326, similar to removing mutually excluded records at 306 in process 300 shown in FIG. 3A.

If there are no existing rules (“no” at 325), or once the mutually excluded records are removed at 326, the process 320 determines the availability of a partial rule, related to the constraint check initiated at 322, at 327, similar to the partial rule check at 307 in process 300 shown in FIG. 3A.

If a partial rule is available (“yes” at 327), then the data set may be filtered at 328, similar to filtering the data set at 308 in process 300 shown in FIG. 3A.

If there is not a partial rule (“no” at 327), or once the data set is filtered at 328, the process 320 may determine if the data set accessed is empty at 329. Determining that the data set is empty at 329 generally includes determining that there is no instance data (e.g. records) in the data set once records that meet an existing rule are removed (e.g. at 326) and records that do not meet the partial rule are removed (e.g. at 328).

If the data set is empty (e.g. “yes” at 329), a constraint message may be provided at 330. Providing a constraint message may include providing a message in a user interface indicating that the data set is empty. For example, the message “No data available for this rule” or “Constraint Warning—data set empty” or other message may be provided for display to a user. Such a message may indicate that there is no data that matches the current rule, or rule being generated. Alternatively or additionally, a constraint or error code may be provided as the message, such as for use by another system accessing the process 320 through an API, for example.

If the constraint checking process 320 is integrated with an automatic rule generation process 300, the rule generation process may be responsive to the detection of an empty data set at 329 or the message provided at 330. For example, such an automatic rule generation process (e.g. 300) may not generate a rule if the data set is empty. In other embodiments, such an automatic rule generation process (e.g. 300) may generate a rule, such as providing the possible values without scores, while providing a warning message (e.g. as at 330).

If the data set is not empty (e.g. “no” at 329), the process 320 may conclude, as there is at least one record in the data set available for analysis. If the constraint checking process 320 is integrated with an automatic rule generation process 300, the rule generation process may proceed as described herein, or may remain otherwise unaffected (e.g. if the process 300 has already completed or otherwise proceeded).

### EXAMPLE 8

### Mutual Exclusion Constraint Checking

FIG. 3C is a flowchart illustrating a process 340 for mutual exclusion rule constraint checking. The process 340 may be integrated with the automatic rule generation process 300 or other constraint checking processes (e.g. 320), or some combination thereof. For example, steps 345 and 346 may be integrated into an automatic rule generation process 300.

Constraint checking may be initiated at 342, which may be similar to initiating constraint checking at 322 in process 320 as shown in FIG. 3B. Generally, initiating a constraint check at 342 may include receiving or otherwise having available a partial rule or a current rule (which may be complete or partial).

A rule set may be accessed at 344, which may be similar to accessing the data set at 324 in process 320 shown in FIG. 3B. Accessing the rule set at 344 may include accessing one or more current or existing rules, such as a mapping (e.g. set of rules) or a rule repository (which may contain one or more mappings). The rule set to be accessed at 344 may be identified by the context of the initiated constraint check, such as a mapping currently being developed or otherwise loaded into local memory, or by receiving one or more rules, or one or more identifiers for rules.

The process 340 may determine at 345 if the partial or current rule matches one or more of the rules accessed at 344. A match between rules at 345 may be a functional match, as in, rules that are functionally equivalent even if written differently. The match at 345 may also include a simple match, such as equivalence between strings or substrings that are complete logic statements, or a fuzzy logic match between strings or substrings that are complete logic statements. A match between rules at 345 may include rules that identify the same records, or a subset of the same records (e.g. a partial functional match). For example, an existing rule may be “field1=‘V1A’” and a current or partial rule may be “field1=‘V1A’ and field2=‘V2A’.” Such rules would be a match, because the current or partial rule identifies a subset of records of the existing rule (e.g. both rules would fire, or be activated by, or apply to, the same records).

If the partial or current rule matches an existing rule (e.g. “yes” at 345), a constraint message may be provided at 346, similar to providing a constraint message at 330 in process 320 shown in FIG. 3B. Providing a constraint message may include providing a message in a user interface indicating that the data set is empty. For example, the message “Rule Match Detected” or “Constraint Warning—rule already exists” or other message may be provided for display to a user. Such a message may indicate that there is an existing rule that applies to the same data as the current or partial rule. Alternatively or additionally, a constraint or error code may be provided as the message, such as for use by another system accessing the process 340 through an API, for example.

If the constraint checking process 340 is integrated with an automatic rule generation process 300, the rule generation process may be responsive to the detection of a rule match at 345 or the message provided at 346. For example, such an automatic rule generation process (e.g. 300) may not generate a rule if there is a rule match. In other embodiments, such an automatic rule generation process (e.g. 300) may generate a rule while providing a warning message (e.g. as at 346).

If the partial or current rule does not match an existing rule (e.g. “no” at 345), the process 340 may conclude, as the current or partial rule does not overlap with an existing rule. If the constraint checking process 340 is integrated with an automatic rule generation process 300, the rule generation process may proceed as described herein, or may remain otherwise unaffected (e.g. if the process 300 has already completed or otherwise proceeded).

### EXAMPLE 9

### Automatic Rule Generation with Attribute Input Example

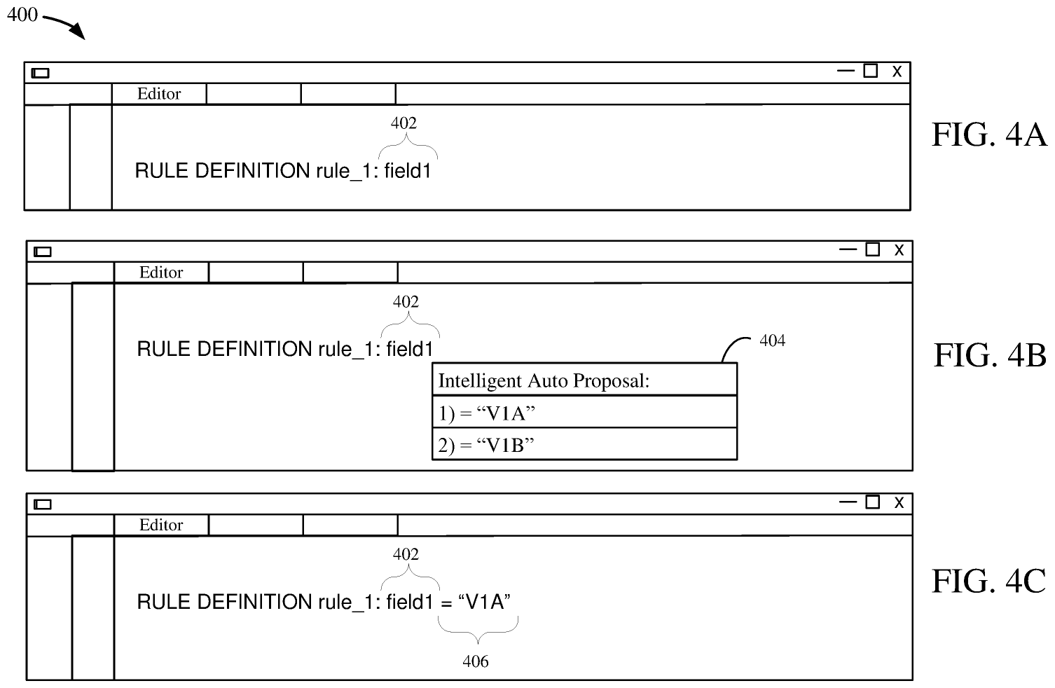

FIGS. 4A-C are diagrams depicting an example 400 for rule building with an attribute. The example 400 illustrates an automatic rule generation process, such as process 300 shown in FIG. 3A, and a user interface.

FIG. 4A illustrates the beginning of the example 400 for automatic rule generation. An attribute name (field1) 402 is input, such as by a user, into a rule definition interface. The attribute 402 may be provided to, or accessed by, an automatic rule generation process. Entering the attribute name “field1” 402 may trigger the automatic rule generation process. Alternatively or additionally, the process may be initiated by a user action, such as via a button or keyboard command.

The automatic rule generation process may determine one or more rule proposals 404 based on the attribute 402, as shown in FIG. 4B. The rule proposals 404 may be provided in a pop-up window/menu or otherwise in the user interface. The rule proposals 404 may be shown near or otherwise arranged in relationship to the attribute 402. Based on the example previously described as for FIG. 2, the rule proposals may be “=‘V1A’” as it has the highest probability (0.7) of the available possible values for field1, and “=‘V1B’” as it has the second highest probability (0.2) of the available possible values for field1. The proposed rules 404 may be selectable by a user.

A rule proposal 404 may be selected and complete the rule as shown in FIG. 4C. The selected rule 406 may be added to the attribute in the rule being defined, completing the rule. The rule 406 may be selected through the user interface or otherwise entered by a user. In some cases, the completed, auto-generated rule 402, 406 may be a partial rule, such as when a user adds an additional field to the rule (e.g. enters “and field2”). Selection of a proposed rule 404 generally completes the auto-generation process by inserting the selected proposed rule (e.g. 406) into the current rule (e.g. 402).

### EXAMPLE 10

### Automatic Rule Generation with Attribute and Partial Rule Input Example

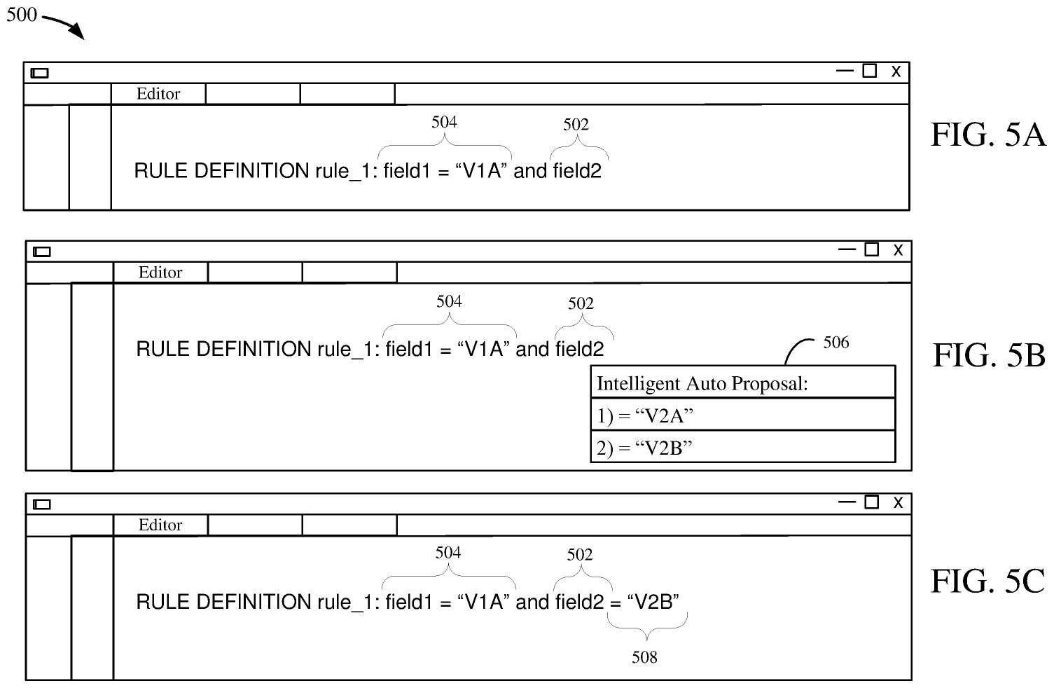

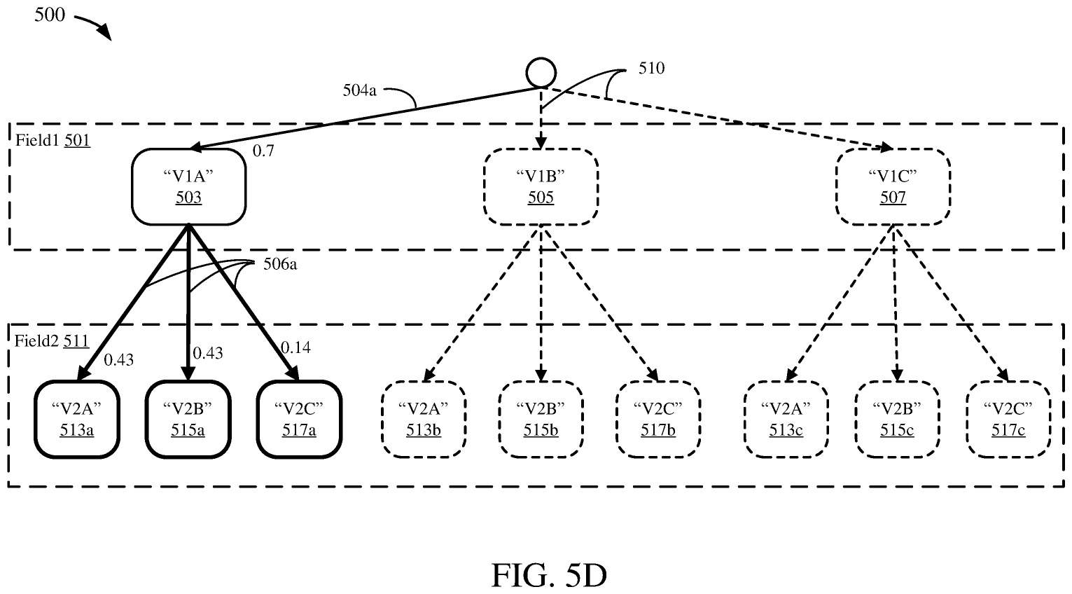

FIGS. 5A-D are diagrams depicting an example 500 for rule building with an attribute and a partial rule. The example 500 illustrates an automatic rule generation process, such as process 300 shown in FIG. 3A, and a user interface, similar to example 400 shown in FIGS. 4A-C.

FIG. 5A illustrates the beginning of the example 500 for automatic rule generation. An attribute name (field2) 502 is input, such as by a user, into a rule definition interface. The attribute 502 may be added to a partial rule 504, which generally is a rule currently being developed. The attribute 502 and the partial rule 504 may be provided to, or accessed by, an automatic rule generation process. Entering the attribute name “field2” 502 may trigger the automatic rule generation process. Alternatively or additionally, the process may be initiated by a user action, such as via a button or keyboard command.

The automatic rule generation process may determine one or more rule proposals 506 based on the attribute 502 and the partial rule 504, as shown in FIG. 5B. The rule proposals 506 may be provided in a pop-up window/menu or otherwise in the user interface. The rule proposals 506 may be shown near or otherwise arranged in relationship to the attribute 502. The rule proposals 506 may be selectable by a user.

A rule proposal 506 may be selected and complete the rule as shown in FIG. 5C. The selected rule 508 may be added to the attribute 502 in the rule being defined including the partial rule 504, completing the rule. The rule 508 may be selected through the user interface or otherwise entered by a user. In some cases, the completed, auto-generated rule 502, 504, 508 may be a partial rule, such as when a user adds an additional field to the rule (e.g. enters “and field2”). Selection of a proposed rule 506 generally completes the auto-generation process by inserting the selected proposed rule (e.g. 508) into the current rule (e.g. 502, 504).

The proposed rules 506 may be determined based on analysis of a data set having instance data of the attribute 502 and the partial rule 504 (e.g. of field1 and field2). Based on the example previously described as for FIG. 2, the rule proposals may be “=‘V2A’” and “=‘V2B’.” FIG. 5D illustrates a probability tree 500 which may be used to generate the proposed rules.

The probability tree 500 may have values “V1A” 503, “V1B” 505, and “V1C” 507 for field1 501 and values “V2A” 513a-c, “V2B” 515a-c, and “V2C” 517a-c for field2 511, similar to FIG. 2. The entire tree 500 may not be needed or used, however, because there is a partial rule 504, where field1 501 has the value “V1A” 503. Thus, only the part of the tree on path 504a for the attribute value in the partial rule 504 need be considered. The other paths 510 for the other values of field1 501 can be filtered from the data set, which means records where field1 has a value other than “V1A” can be filtered from the data set. Thus, for field2, only the options 506a need be considered to determine rule proposals for the attribute 502 and partial rule 504.

Determining the scores for each of the possible values 513a, 515a, 517a for the attribute 502 (e.g. field2 511) may be done by multiplying the probability of each by the probability of the partial rule 504, which is 0.7 for value “V1A” 503 for field1 501. Thus, “V2A” 513a has a probability of 0.7*0.43=0.301, “V2B” 515a has a probability of 0.7*0.43=0.301, and “V2C” 517a has a probability of 0.7*0.14=0.098. Accordingly, values “V2A” 513a and “V2B” 515a are provided as the proposed rules, as they have the highest scores or probabilities.

### EXAMPLE 11

### Automatic Rule Generation with Attribute, Partial Rule, and Existing Rule Input Example

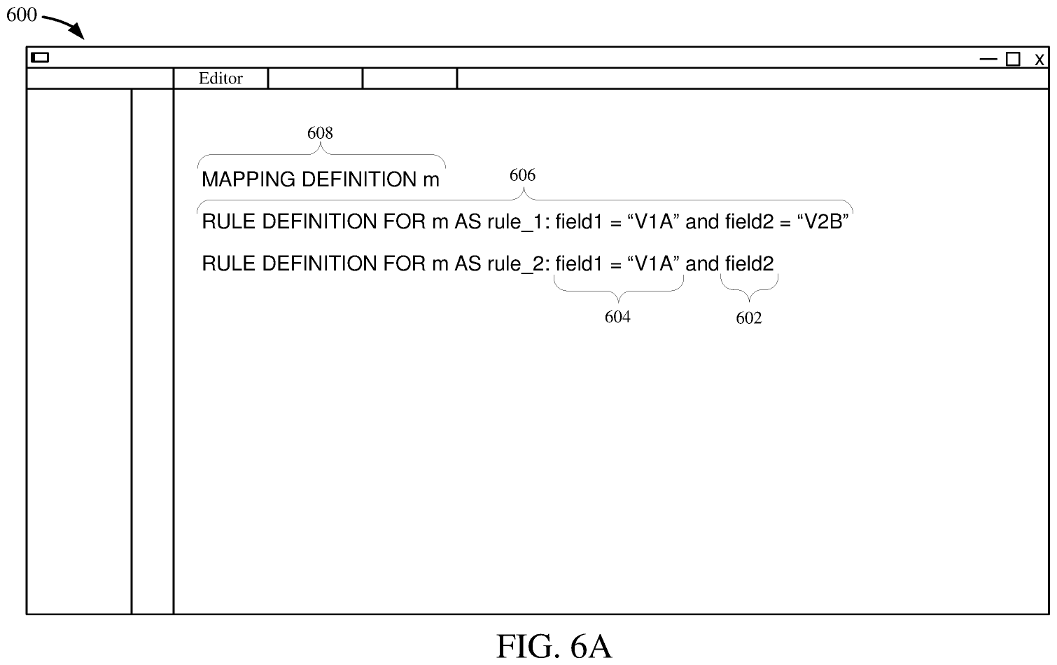

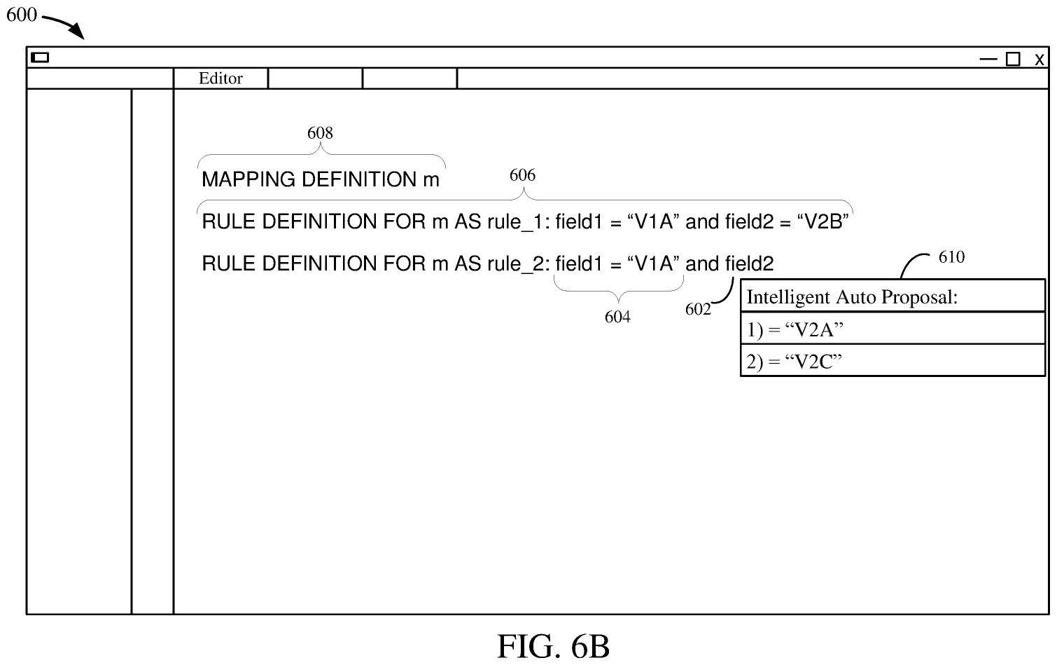

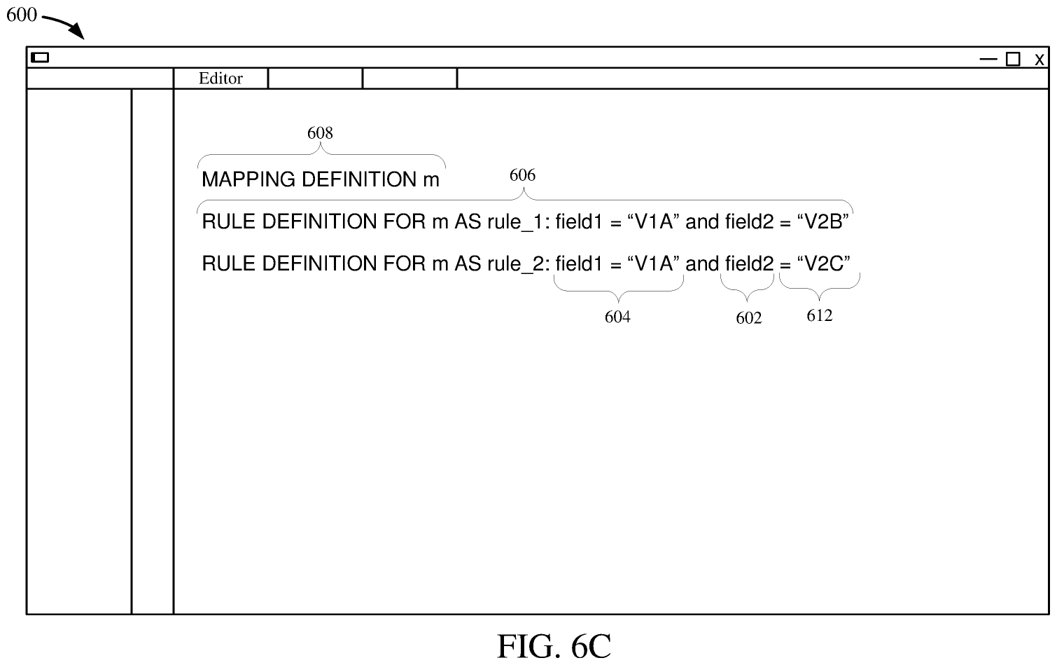

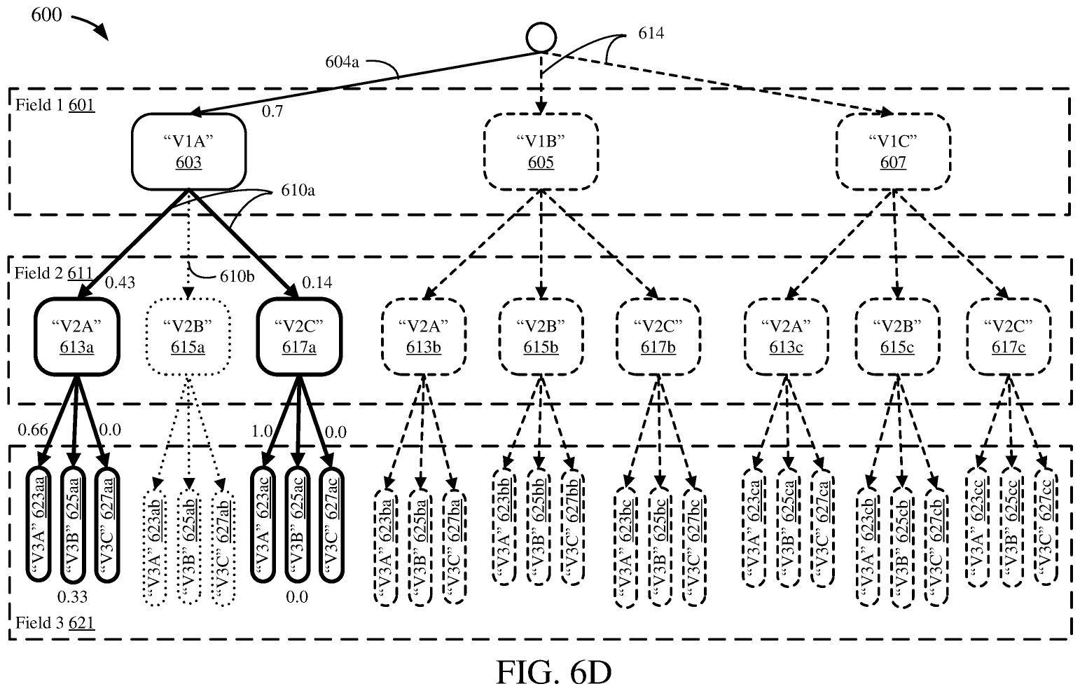

FIGS. 6A-D are diagrams depicting an example 600 for rule building with an attribute, a partial rule, and an existing rule. The example 600 illustrates an automatic rule generation process, such as process 300 shown in FIG. 3A, and a user interface, similar to example 400 shown in FIGS. 4A-C and example 500 shown in FIGS. 5A-D.

FIG. 6A illustrates the beginning of the example 600 for automatic rule generation. An attribute name (field2) 602 is input, such as by a user, into a rule definition interface. The attribute 602 may be added to a partial rule 604, which generally is a rule currently being developed. An existing rule 606 may be available, such as may have already been completed or auto-generated. The existing rule 606 may be part of a set of rules, or mapping, 608. The rule currently being developed 602, 604 may be part of the mapping 608.

The attribute 602, the partial rule 604, and the existing rule 606 and/or mapping 608 may be provided to, or accessed by, an automatic rule generation process. Entering the attribute name “field2” 602 may trigger the automatic rule generation process. Alternatively or additionally, the process may be initiated by a user action, such as via a button or keyboard command.

The automatic rule generation process may determine one or more rule proposals 610 based on the attribute 602, the partial rule 604, and the existing rule 606, as shown in FIG. 6B. The automatic generation process may use the mapping 608, such as when multiple existing rules are available, or the automatic generation process may access the existing rule 606 through the mapping 608 (e.g. the process accesses the mapping to identify and use available existing rules). The rule proposals 610 may be provided in a pop-up window/menu or otherwise in the user interface. The rule proposals 610 may be shown near or otherwise arranged in relationship to the attribute 602. The proposed rules 610 may be selectable by a user.

A rule proposal 610 may be selected and may complete the rule as shown in FIG. 6C. The selected rule 612 may be added to the attribute 602 in the rule being defined including the partial rule 604, completing the rule. The rule 612 may be selected through the user interface or otherwise entered by a user. In some cases, the completed, auto-generated rule 602, 604, 612 may be a partial rule, such as when a user adds an additional field to the rule (e.g. enters “and field2”). Selection of a proposed rule 610 generally completes the auto-generation process by inserting the selected proposed rule (e.g. 610) into the current rule (e.g. 602, 604). The completed rule 602, 604, 612 may be part of the mapping 608, or be added to the mapping, as an existing rule.

The proposed rules 610 may be determined based on analysis of a data set having instance data of the attribute 602 and the partial rule 604 (e.g. of field1 and field2), and further based on the existing rule 606 related to the current rule 602, 604, such as via mapping 608. Based on the example previously described as for FIG. 2, the rule proposals may be “=‘V2A’” and “=‘V2C’.” FIG. 6D illustrates a probability tree 600 which may be used to generate the proposed rules.

The probability tree 600 may have values “V1A” 603, “V1B” 605, and “V1C” 607 for field1 601, values “V2A” 613a-c, “V2B” 615a-c, and “V2C” 617a-c for field2 611, and values “V3A” 623aa-cc, “V3B” 625aa-cc, and “V3C” 627aa-cc for field3 621, similar to FIG. 2. The entire tree 600 may not be needed or used, however, because there is a partial rule 604, where field1 601 has the value “V1A” 603, and an existing rule 606, where field1 601 has the value “V1A” 603 and field2 has the value “V2B” 615a. Thus, only the part of the tree on path 604a for the attribute value in the partial rule 604 need be considered. The other paths 614 for the other values of field1 601 can be filtered from the data set, which means records where field1 has a value other than “V1A” can be filtered (e.g. removed) from the data set.

Further, mutually excluded paths (e.g. records) can be removed based on the existing rule 606 (which can include additional or all existing rules in the mapping 608). Thus, records covered by path 610b, which are records that meet the existing rule 606, can be removed as well, because they are excluded by the existing rule. Removing records on path 610b ensures that the new rule being developed 602, 604 is mutually exclusive compared to the existing rule 606 (e.g. that the rules do not overlap and are independent).

Thus, for field2, only the options 610a need be considered to determine rule proposals for the attribute 602, the partial rule 604, and the existing rule 606.

This analysis identifies two possible values for field2 611 (e.g. attribute 602): “V2A” 613a and “V2C” 617a). With only two possible values, or any low number of possible values (e.g. such as determined by a configurable setting), both options may be provided to the user as described herein, without calculation of their scores. However, scores may still be calculated, such as to provide to a user or to order the options. Determining the scores for each of the possible values 613a, 617a for the attribute 602 (e.g. field2 611) may be done by multiplying the probability of each by the probability of the partial rule 604, which is 0.7 for value “V1A” 603 for field1 601. Thus, “V2A” 613a has a probability of 0.7*0.43=0.301, and “V2C” 617a has a probability of 0.7*0.14=0.098. Accordingly, values “V2A” 613a and “V2C” 617a are provided as the proposed rules, as they have the highest scores or probabilities, and are the only available options. In some cases, value “V2C” 617a may be not be provided based on having a low score, such as compared to a score threshold (e.g. a configurable setting).

Field3 621 in the example probability tree 600 illustrates the possible options if the current rule 602, 604, 612 is further extended to include field3 (e.g. is a partial rule).

### EXAMPLE 12

### Constraint Checking Data Set Example

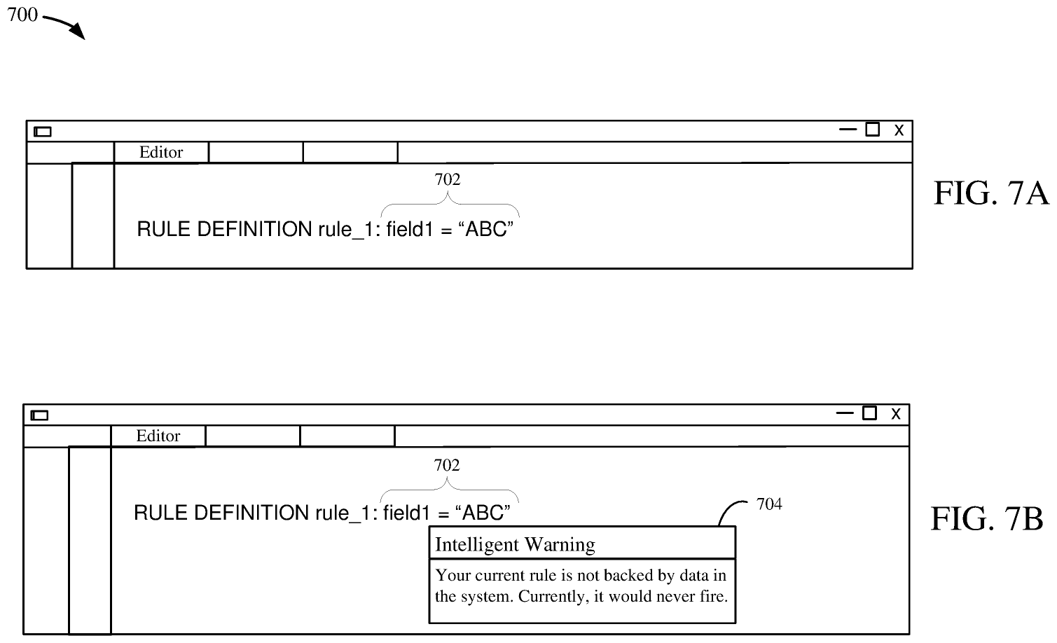

FIGS. 7A-B are diagrams depicting an example 700 for data set constraint checking. The example 700 may use the data set shown in and described for FIG. 2. FIG. 7A illustrates a rule 702, which may have been generated by an automatic rule generation process as described herein. The example 700 illustrates a constraint checking process of the data set, such as process 320 shown in FIG. 3B, and a user interface, similar to example 400 shown in FIGS. 4A-C, example 500 shown in FIGS. 5A-D, and example 600 shown in FIGS. 6A-D.

The constraint checking process may analyze the records in the data set and determine that no records have the value “ABC” for field1, as indicated in the rule 702. Alternatively or additionally, the constraint checking process may determine that “ABC” is not a defined value for field1, such as based on the definition of field1. Accordingly, the constraint checking process may provide a message 704, as shown in FIG. 7B. The message 704 may indicate that there is no data in the applicable data set which matches the rule 702, and accordingly, the rule may not be triggered. The message 704 may be provided in a pop-up window or frame, or may be otherwise displayed, and arranged in relationship to the rule 702 (e.g. the rule to which it applies).

### EXAMPLE 13

### Constraint Checking Rule Set Example

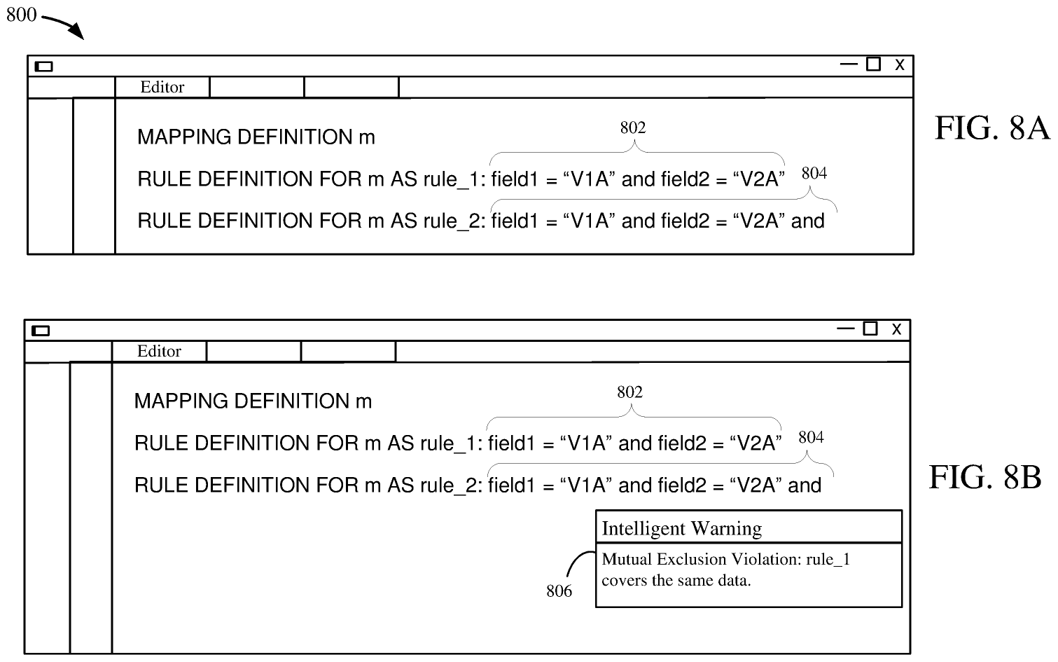

FIGS. 8A-B are diagrams depicting an example for mutual exclusion constraint checking. The example 800 may use the data set shown in and described for FIG. 2. FIG. 8A illustrates a rule 802 defined in a mapping (e.g. an existing rule) and another rule 804, which may also exist in the same mapping, and may be in the process of being generated or which may have been generated by an automatic rule generation process as described herein. The example 800 illustrates a constraint checking process of the rule set or mapping, such as process 340 shown in FIG. 3C, and a user interface, similar to example 400 shown in FIGS. 4A-C, example 500 shown in FIGS. 5A-D, example 600 shown in FIGS. 6A-D, and example 700 shown in FIGS. 7A-B.

The constraint checking process may analyze the current rule against the other rules in the mapping. For example 800, rule 804 may be compared against rule 802. Because both existing rule 802 and current rule 804 have “V1A” as the value for field1 and “V2A” as the value for field2 (and use the equivalence comparator), both rules are not mutually exclusive. Accordingly, the constraint checking process may provide a message 806, as shown in FIG. 8B. The message 806 may indicate that the rules 802, 804 are not mutually exclusive, and accordingly, both rules will be triggered at the same time, or apply to the same records. Extending rule 804, such as to include a field3, may still trigger the constraint checking, as rule 804 is then a subset of rule 802. The message 806 may be provided in a pop-up window or frame, or may be otherwise displayed, and arranged in relationship to the rule 804 (e.g. the rule to which it applies, which may generally be the current rule or rule in development).

### EXAMPLE 14

### Rule Builder Module Environments

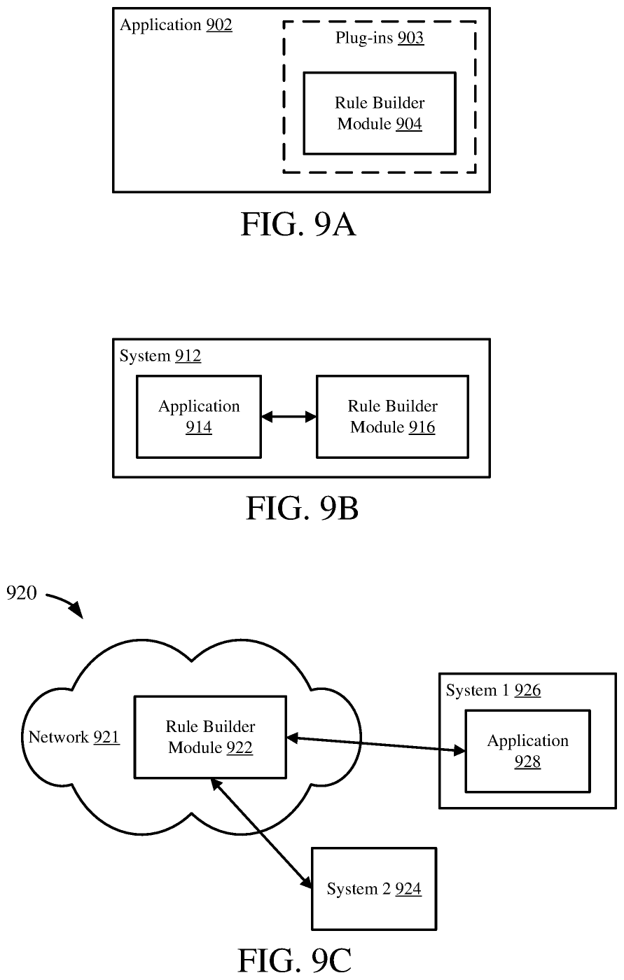

FIG. 9A is a schematic diagram depicting an application environment for a rule builder module 904, which may provide automatic rule generation and constraint checking functionality as described herein. An application 902, such as a software application running in a computing environment, may have one or more plug-ins 903 (or add-ins or other software extensions to programs) that add functionality to, or otherwise enhance, the application. The rule builder module 904 may be integrated with the application 902; for example, the rule builder module may be integrated as a plug-in. The rule builder module 904 may add functionality to the application 902 for automatic rule generation and constraint checking, which may be displayed in a user interface or otherwise provided to a user. For example, the application 902 may be a database or data modeling application, or a database management application, and the rule builder module 904 may be integrated with the database or data management application to provide automatic rule generation and constraint checking functionality.

FIG. 9B is a schematic diagram depicting a system environment for a rule builder module 916, which may provide automatic rule generation and constraint checking functionality as described herein. The rule builder module 916 may be integrated with a computer system 912. The computer system 912 may include an operating system, or otherwise be a software platform, and the rule builder module 916 may be an application or service running in the operating system or platform, or the rule builder module may be integrated within the operating system or platform as a service or functionality provided through the operating system or platform. The system 912 may be a server or other networked computer or file system. Additionally or alternatively, the rule builder module 916 may communicate with and provide automatic rule generation and constraint checking functionality, as described herein, to one or more applications 914, such as a database, data modeling, or database management applications, in the system 912.

FIG. 9C is a schematic diagram depicting a network environment 920 for a rule builder module 922, which may provide automatic rule generation and constraint checking functionality as described herein. The rule builder module 922 may be available on a network 921, or integrated with a system (such as from FIG. 9B) on a network. Such a network 921 may be a cloud network or a local network. The rule builder module 922 may be available as a service to other systems on the network 921 or that have access to the network (e.g., may be on-demand software or SaaS). For example, system 2 924 may be part of, or have access to, the network 921, and so can utilize automatic rule generation and constraint checking functionality from the rule builder module 922. Additionally, system 1 926, which may be part of or have access to the network 921, may have one or more applications, such as application 928, that may utilize automatic rule generation and constraint checking functionality from the rule builder module 922.

In these ways, the rule builder module 904, 916, 922 may be integrated into an application, a system, or a network, to provide automatic rule generation and constraint checking functionality as described herein.

### EXAMPLE 15

### Computing Systems

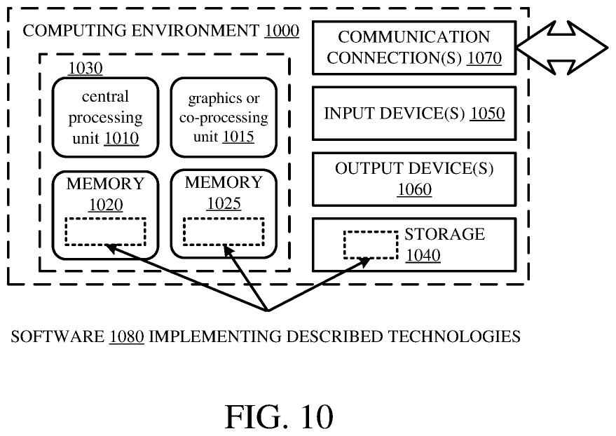

FIG. 10 depicts a generalized example of a suitable computing system 1000 in which the described innovations may be implemented. The computing system 1000 is not intended to suggest any limitation as to scope of use or functionality of the present disclosure, as the innovations may be implemented in diverse general-purpose or special-purpose computing systems.

With reference to FIG. 10, the computing system 1000 includes one or more processing units 1010, 1015 and memory 1020, 1025. In FIG. 10, this basic configuration 1030 is included within a dashed line. The processing units 1010, 1015 execute computer-executable instructions, such as for implementing components of the processes of FIGS. 3A-C, the systems of FIGS. 1A-B and 9A-C, or the databases, data representations, and displays of FIG. 2, FIGS. 4A-C, 5A-D, 6A-D, 7A-B, and 8A-B. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s) 1010, 1015. The memory 1020, 1025 stores software 1080 implementing one or more innovations described herein, in the form of computer-executable instructions suitable for execution by the processing unit(s) 1010, 1015. The memory 1020, 1025, may also store settings or settings characteristics, databases, data sets, interfaces, displays, or data models or representations shown in FIG. 2, FIGS. 4A-C, 5A-D, 6A-D, 7A-B, and 8A-B, systems shown in FIGS. 1A-B and 9A-C, or the steps of the processes shown in FIGS. 3A-C.

A computing system 1000 may have additional features. For example, the computing system 1000 includes storage 1040, one or more input devices 1050, one or more output devices 1060, and one or more communication connections 1070. An interconnection mechanism (not shown) such as a bus, controller, or network interconnects the components of the computing system 1000. Typically, operating system software (not shown) provides an operating environment for other software executing in the computing system 1000, and coordinates activities of the components of the computing system 1000.

The tangible storage 1040 may be removable or non-removable, and includes magnetic disks, magnetic tapes or cassettes, CD-ROMs, DVDs, or any other medium which can be used to store information in a non-transitory way and which can be accessed within the computing system 1000. The storage 1040 stores instructions for the software 1080 implementing one or more innovations described herein.

The input device(s) 1050 may be a touch input device such as a keyboard, mouse, pen, or trackball, a voice input device, a scanning device, or another device that provides input to the computing system 1000. The output device(s) 1060 may be a display, printer, speaker, CD-writer, or another device that provides output from the computing system 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general purpose program, such as one or more lines of code in a larger or general purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### EXAMPLE 16

### Cloud Computing Environment

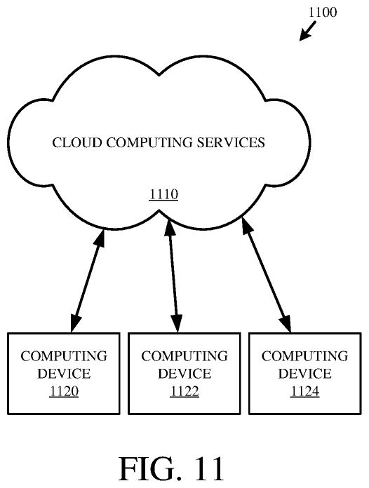

FIG. 11 depicts an example cloud computing environment 1100 in which the described technologies can be implemented. The cloud computing environment 1100 comprises cloud computing services 1110. The cloud computing services 1110 can comprise various types of cloud computing resources, such as computer servers, data storage repositories, networking resources, etc. The cloud computing services 1110 can be centrally located (e.g., provided by a data center of a business or organization) or distributed (e.g., provided by various computing resources located at different locations, such as different data centers and/or located in different cities or countries).

The cloud computing services 1110 are utilized by various types of computing devices (e.g., client computing devices), such as computing devices 1120, 1122, and 1124. For example, the computing devices (e.g., 1120, 1122, and 1124) can be computers (e.g., desktop or laptop computers), mobile devices (e.g., tablet computers or smart phones), or other types of computing devices. For example, the computing devices (e.g., 1120, 1122, and 1124) can utilize the cloud computing services 1110 to perform computing operations (e.g., data processing, data storage, and the like).

### EXAMPLE 17

### Implementations

Although the operations of some of the disclosed methods are described in a particular, sequential order for convenient presentation, it should be understood that this manner of description encompasses rearrangement, unless a particular ordering is required by specific language set forth. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 10, computer-readable storage media include memory 1020 and 1025, and storage 1040. The term computer-readable storage media does not include signals and carrier waves. In addition, the term computer-readable storage media does not include communication connections (e.g., 1070).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. It should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as HTML or XML, or combinations of suitable programming languages and markup languages. Likewise, the disclosed technology is not limited to any particular computer or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

### EXAMPLE 18

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A method of generating at least a portion of a proposed logic statement, the method comprising:
receiving an attribute identifier of an attribute having a set of possible values;
accessing a data set, wherein the data set is at least partially defined by the attribute;
calculating a set of probability scores of the attribute based on the data set, wherein a given probability score corresponds to a given value of the set of possible values of the attribute; and
providing at least one proposed value from the set of possible values of the attribute based on the set of probability scores.

2. The method of claim 1, further comprising:
sorting the set of possible values of the attribute based on their respective probability scores; and
wherein the at least one proposed value is provided as an ordered set based on the sorting.

3. The method of claim 1, further comprising:
cleaning the data set, wherein cleaning comprises removing one or more records from the data set where the first rule value does not match the first rule attribute according to a partial rule; and
wherein calculating the set of probability scores is based on the cleaned data set.

4. The method of claim 1, further comprising:
cleaning the data set, wherein cleaning the data set comprises removing one or more records from the data set that match an existing rule; and
wherein calculating the set of probability scores is based on the cleaned data set.

5. The method of claim 1, further comprising:
receiving a selected proposed value, wherein the selected proposed value is one of the provided at least one proposed values from the set of possible values; and
generating a logic statement based on the attribute identifier and the selected proposed value.

6. The method of claim 5, further comprising:
storing the generated logic statement.

7. The method of claim 5, further comprising:
executing the generated logic statement based on an execution data set.

8. The method of claim 1, wherein providing the at least one proposed value comprises:
automatically selecting a proposed value from the set of possible values of the attribute based on the set of probability scores;
generating a logic statement based on the attribute identifier and the selected proposed value; and
providing the generated logic statement.

9. The method of claim 1, further comprising:
determining a comparator based on the attribute and the data set; and
providing the comparator with the at least one proposed value.

10. The method of claim 1, further comprising:
analyzing the data set to determine a number of records applicable to the received attribute identifier; and
responsive to no records being applicable to the received attribute, providing a message indicating no records are applicable.

11. The method of claim 1, further comprising:
receiving a partial rule comprising a first rule attribute associated with a first rule value;
comparing the partial rule to one or more existing rules; and
responsive to a match between the partial rule and at least one of the one or more existing rules, providing a message indicating the match.

12. One or more non-transitory computer-readable storage media storing computer-executable instructions causing a computing system to perform a method of providing one or more proposed logic statements, the method comprising:
receiving a request for a proposed logic statement, wherein the request comprises a requested attribute identifier of an attribute having a set of possible values and a partial rule comprising at least a first rule attribute associated with a first rule value;
accessing a data set having one or more records, wherein the data set is at least partially defined by the requested attribute and the first rule attribute;
filtering the data set, wherein filtering comprises removing one or more records from the data set where the first rule value does not match the first rule attribute;
calculating a set of probability scores of the requested attribute based on the filtered data set, wherein a given probability score corresponds to a given value of the set of possible values of the requested attribute; and
providing at least one proposed logic statement comprising the requested attribute and a proposed value from the set of possible values based on the set of probability scores.

13. The one or more non-transitory computer-readable storage media of claim 12, wherein the method further comprises:
sorting the set of possible values of the requested attribute based on their respective probability scores; and
wherein the at least one proposed logic statement is provided as an ordered set based on the sorting.

14. The one or more non-transitory computer-readable storage media of claim 12, wherein the method further comprises:
cleaning the data set, wherein cleaning the data set comprises removing one or more records from the data set that match an existing rule; and
wherein calculating the set of probability scores is based on the cleaned and filtered data set.

15. The one or more non-transitory computer-readable storage media of claim 12, wherein the method further comprises:
receiving a selected proposed logic statement, wherein the selected proposed logic statement is one of the provided at least one proposed logic statement; and
generating a rule based on the selected proposed logic statement.

16. The one or more non-transitory computer-readable storage media of claim 15, wherein the method further comprises:
storing the generated rule.

17. The one or more non-transitory computer-readable storage media of claim 15, wherein the method further comprises:
executing the generated rule based on an execution data set.

18. The one or more non-transitory computer-readable storage media of claim 12, wherein the method further comprises:
automatically selecting a proposed logic statement from the from the at least one proposed logic statement based on the respective probability scores;
generating a rule based on the selected proposed logic statement and the partial rule; and
providing the generated rule.

19. The one or more non-transitory computer-readable storage media of claim 12, wherein the method further comprises:
comparing the partial rule to one or more existing rules; and
responsive to a match between the partial rule and at least one of the one or more existing rules, providing a message indicating the match.

20. A data-driven logic statement generation system comprising:
one or more memories;
one or more processing units coupled to the one or more memories; and
one or more computer readable storage media storing instructions that, when loaded into the one or more memories, cause the one or more processing units to perform automatic logic statement generation operations comprising:
receiving a request for a proposed logic statement, wherein the request comprises a requested attribute identifier of an attribute having a set of possible values and a partial rule comprising at least a first rule attribute associated with a first rule value;
accessing a data set having one or more records, wherein the data set is at least partially defined by the requested attribute and the first rule attribute;
updating the data set, wherein updating the data set comprises removing one or more records from the data set that match an existing rule;
filtering the updated data set, wherein filtering the data set comprises removing one or more records from the updated data set that do not have the first rule value of the first rule attribute;
calculating a set of probability scores of the requested attribute based on the filtered data set, wherein a given probability score corresponds to a given value of the set of possible values of the requested attribute;
sorting the set of possible values of the requested attribute based on their respective probability scores; and
providing at least one proposed logic statement comprising the requested attribute identifier and a proposed value from the set of possible values based on the set of probability scores.
